(19) United States
(12) Patent Application Publication
(10) Pub. No.: US 2014/0167335 A1
(43) Pub. Date: Jun. 19, 2014

(54) METHOD OF MANUFACTURING COIL

(71) Applicant: Samsung Electro-Mechanics Co., Ltd., Suwon (KR)

(72) Inventors: Sang Ho SHIN, Anyang (KR); Byung Kug CHO, Suwon (KR); Hoon Seok HUR, Hwasung (KR)

(73) Assignee: Samsung Electro-Mechanics Co., Ltd., Suwon (KR)

(21) Appl. No.: 14/132,536

(22) Filed: Dec. 18, 2013

(30) Foreign Application Priority Data
Dec. 18, 2012 (KR) 10-2012-0148430

(51) Int. Cl. H01F 41/04

(52) U.S. Cl. CPC H01F 41/04
USPC 264/611; 264/272.19

(57) ABSTRACT

Disclosed herein is a method of manufacturing a coil, including: preparing a mold having vertically movable fixing pins disposed therein and slidable left and right sidewalls; seating a magnetic plate on an inner bottom of the mold; loading the coil on the magnetic plate so that lead parts of the coil are disposed between the fixing pins and the sidewalls of the mold; sliding the left and right sidewalls of the mold into the mold to closely adhere the lead parts of the coil to the fixing pins; filling a magnetic slurry in the mold and primarily pressing the magnetic slurry; and lowering the fixing pins to perform secondary pressing, in order to prevent deformation or position deviation of the coil at the time of molding the coil.

### CROSS REFERENCE(S) TO RELATED APPLICATIONS

This application claims the foreign priority benefit under 35 U.S.C. Section 119 of Korean Application No. 10-2012-0148430, entitled “Method of Manufacturing Coil” filed on Dec. 18, 2012, which is hereby incorporated by reference in its entirety into this application.

### BACKGROUND OF THE INVENTION

1. Technical Field

The present invention relates to a method of manufacturing a coil, and more particularly, to a method of manufacturing a coil by molding.

2. Description of the Related Art

Recently, as a portable information communication device has been continuously miniaturized, various components configuring the portable information communication device have also been demanded to be ultra-thinned. Particularly, a surface mounting type coil included in a power supply circuit should have a thickness that is ultra-thinned to 1.0 mm or less in order to satisfy a design condition required by the portable information communication device.

Since slimness, electrical characteristics, and mechanical strength are important in the surface mounting type coil as described above, a complex technology is required in order to implement a method of designing and manufacturing the surface mounting type coil.

A general method of manufacturing the surface mounting type coil according to the related art will be described. After a coil wound around a ferrite core is disposed in an internal space of a mold, the internal space is sealed by a magnetic slurry in a melted state to manufacture a molded product or an air core coil is disposed in the internal space of the mold as it is and is then sealed (Korean Patent Laid-Open Publication No. 10-2008-0022679).

However, at the time of sealing the internal space by the magnetic slurry, the coil disposed in the mold may be deformed depending on a charging pressure of the magnetic slurry. Alternatively, the coil may be biased or inclined toward any one side in the internal space of the mold. Therefore, the coil may be molded in the state in which it deviates from a predetermined position.

The deformation or the position deviation of the coil as described above may cause an appearance defect and have a bad effect on electrical characteristics such as an inductance value, direct current (DC) overlapping characteristics, or the like. Therefore, a technology of preventing the deformation or the position deviation of the coil at the time of molding the coil has emerged.

### RELATED ART DOCUMENT

### Patent Document

(Patent Document 1) Korean Patent Laid-Open Publication No. 10-2008-0022679

### SUMMARY OF THE INVENTION

An object of the present invention is to provide a method of manufacturing a coil capable of securing reliability by preventing a coil in a mold from being deformed or deviating from a predetermined position at the time of molding the coil.

According to an exemplary embodiment of the present invention, there is provided a method of manufacturing a coil, including: preparing a mold having vertically movable fixing pins disposed therein and slidable left and right sidewalls; seating a magnetic plate on an inner bottom of the mold; loading the coil on the magnetic plate so that lead parts of the coil are disposed between the fixing pins and the sidewalls of the mold; sliding the left and right sidewalls of the mold into the mold to closely adhere the lead parts of the coil to the fixing pins; filling a magnetic slurry in the mold and primarily pressing the magnetic slurry; and lowering the fixing pins to perform secondary pressing.

The magnetic plate may have a convex shape.

In the seating of the magnetic plate in the inner bottom of the mold, a convex part may be positioned between the fixing pins.

In the lowering of the fixing pins, the fixing pins may stop when upper distal ends of the fixing pins and an inner bottom surface of the mold are positioned on the same plane.

The method may further include sintering a molded product obtained after the performing of the secondary pressing.

The coil may be an air core coil including a winding part formed by winding a conducting wire in a spiral shape and two lead parts extended from both ends of the winding part and protruding outward.

The magnetic plate and the magnetic slurry may be made of at least one selected from a group consisting of a Fe based material, a Fe—Si based material, a Fe—Al based material, a Fe—Ni based material, and a Fe—Al—Si based material.

The primary pressing and the secondary pressing may be performed by positioning a press plate in an opening part of an upper portion of the mold and pressing the press plate downward, and a compression strength of the primary pressing may be set to be lower than that of the secondary pressing.

### BRIEF DESCRIPTION OF THE DRAWINGS

FIGS. 1A to 6B are views sequentially showing processes of a method of manufacturing a coil according to an exemplary embodiment of the present invention.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art. Like reference numerals throughout the description denote like elements.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

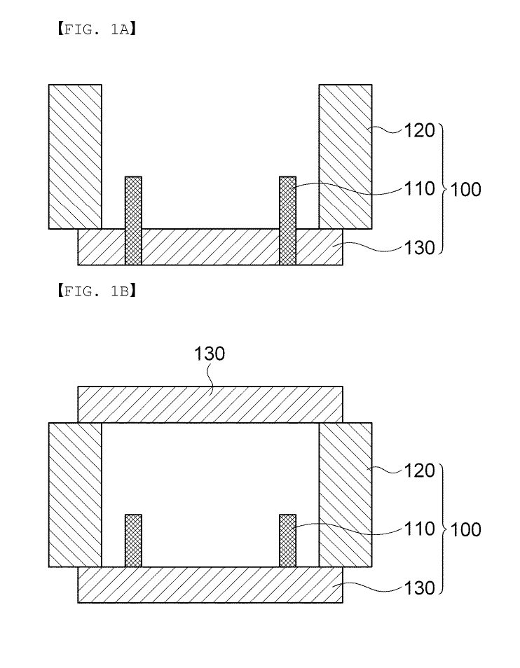

FIGS. 1A to 6B are views sequentially showing processes of a method of manufacturing a coil according to an exemplary embodiment of the present invention. Here, each of the accompanying drawings includes A, which is a cross-sectional view, and B, which is a plan view. Additionally, components shown in the accompanying drawings are not necessarily shown to scale. For example, sizes of some components shown in the accompanying drawings may be exaggerated as compared with other components in order to assist in the understanding of the exemplary embodiments of the present invention.

In the method of manufacturing a coil according to the exemplary embodiment of the present invention, a mold 100 having two fixing pins 110 disposed therein is first prepared, as shown in FIGS. 1A and 1B.

Here, the fixing pin 110 may be designed so as to be vertically movable to the outside of the mold 100. That is, the fixing pin 110 is disposed in the mold 100 as shown in FIGS. 1A and 1B before the subsequent process is performed and is lowered vertically by mechanical driving when the subsequent process is performed.

More specifically, the two fixing pins 110 may be spaced apart from each other by a predetermined interval and be disposed at the same position on a straight line. This structure may depend on a structure of a coil 220 that is subsequently loaded in the mold 100. This structure of the coil 220 will be described below in detail.

Left and right sidewalls 120 of the mold 100 may be designed so as to be slidable horizontally. Therefore, the mold 100 has a structure in which each of the left and right sidewalls 120 is horizontally slid in a body part 130 in which a lower surface portion and front and rear surface portions are connected integrally with each other.

The left and right sidewalls 120 of the mold 100 are disposed at a position at which it is slightly pushed outward as shown in FIGS. 1A and 1B before the coil 220 is loaded in the mold 100 and are slid to an inner portion of the mold 100 by mechanical movement when the coil 220 is loaded in the mold 100.

When the left and right sidewalls 120 are slid to the inner portion of the mold 100, the left and right sidewalls 120 are integrated with the body part 130 of the mold 100, such that a molding frame of which only an upper portion is opened is completed. An inner size of the molding frame having the form as described above, that is, the mold 100 having the left and right sidewalls 120 slid to the inner portion thereof coincides with a specification of the finally completed coil.

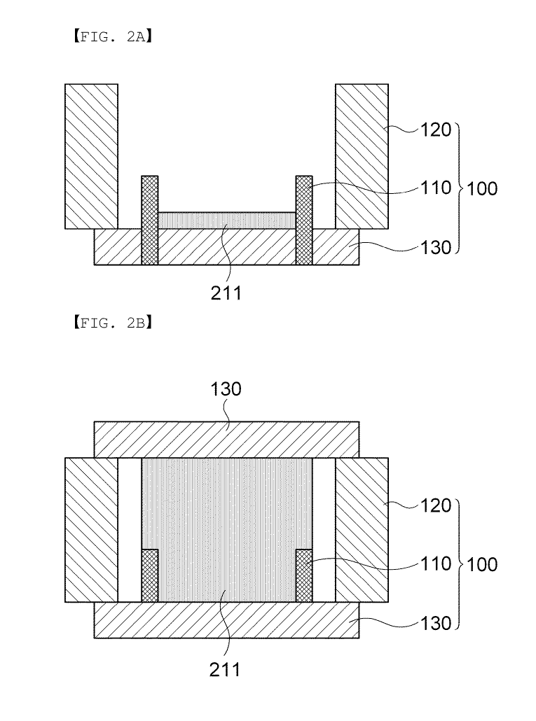

When the mold 100 as described above is prepared, a magnetic plate 211 is seated on an inner bottom of the mold 100, as shown in FIGS. 2A and 2B.

The magnetic plate 211 may be formed of a flat plate that does not have a thickness deviation so that the coil 220 may be loaded without being inclined and have a convex shape as shown in FIG. 2B. Therefore, in the case in which the magnetic plate 211 is seated in the mold 100, a convex part is positioned between the two fixing pins 110.

The magnetic plate 211 may be made of, for example, known ferrite having high magnetic permeability and a soft magnetic metal material. More specifically, the magnetic plate 211 may be made of at least one selected from a group consisting of a Fe based material, a Fe—Si based material, a Fe—Al based material, a Fe—Ni based material, and a Fe—Al—Si based material.

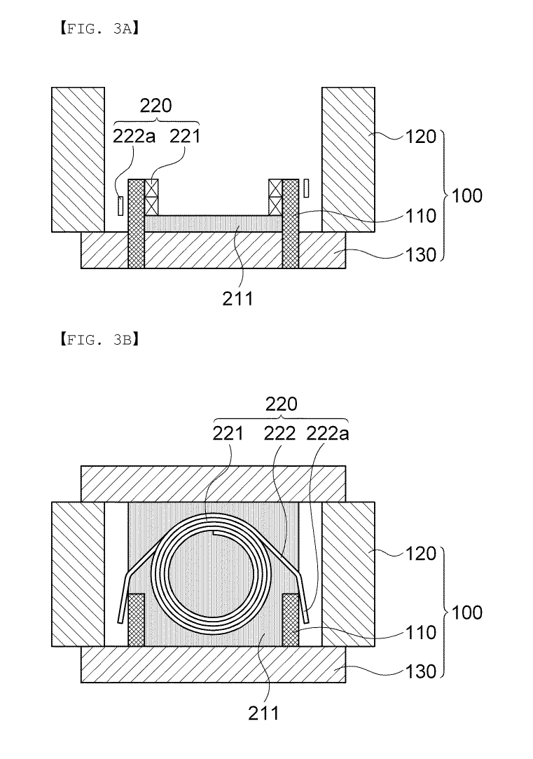

When the magnetic plate 211 is seated on the inner bottom of the mold 100, the coil 220 is loaded on the magnetic plate 211 as shown in FIGS. 3A and 3B.

Here, the coil 220 may be an air core coil. Therefore, the coil 220 may include a winding part 221 formed by winding a conducting wire in a spiral shape and two lead parts 222 extended from both ends of the winding part 221 and protruding outward.

Since the lead parts 222 protruding outward are bent at a predetermined angle, when the coil 220 is loaded on the magnetic plate 211 in the state in which the lead parts 222 are directed toward the fixing pins 110, a left lead part 222 is disposed between a left fixing pin 110 and the left sidewall 120 and a right lead part 222 is disposed between a right fixing pin 110 and the right sidewall 120, as shown in FIGS. 3A and 3B. However, since the lead part 222 has predetermined elasticity, a distal end 222a of the lead part 222 is disposed to be spaced apart from the fixing pin 110.

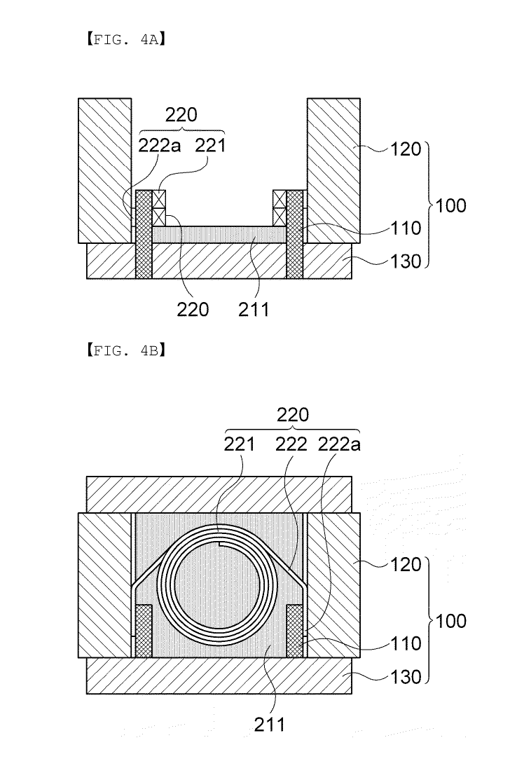

When the coil 220 is loaded on the magnetic plate 211, the left and right sidewalls 120 are slid to the inner portion of the mold 100, as shown in FIGS. 4A and 4B.

As described above, since the distal ends 222a of the lead parts 222 of the coil 220 are disposed between the fixing pins 110 and the sidewalls 120 in the state in which they are spaced apart from the fixing pins 110, when the left and right sidewalls 120 are slid to the inner portion of the mold 100 to be thereby closely adhered to the fixing pins 110, the distal ends 222a of the lead parts 222 are stably fixed between the fixing pins 110 and the sidewalls 120, as shown in FIGS. 4A and 4B.

Therefore, since the coil 220 may be stably loaded on the magnetic plate 211, even though a magnetic slurry is filled in the mold 100 in the subsequent process, a defect such as deformation of the coil, deviation of the coil from a predetermined position, or the like, due to a charging pressure of the magnetic slurry may be prevented.

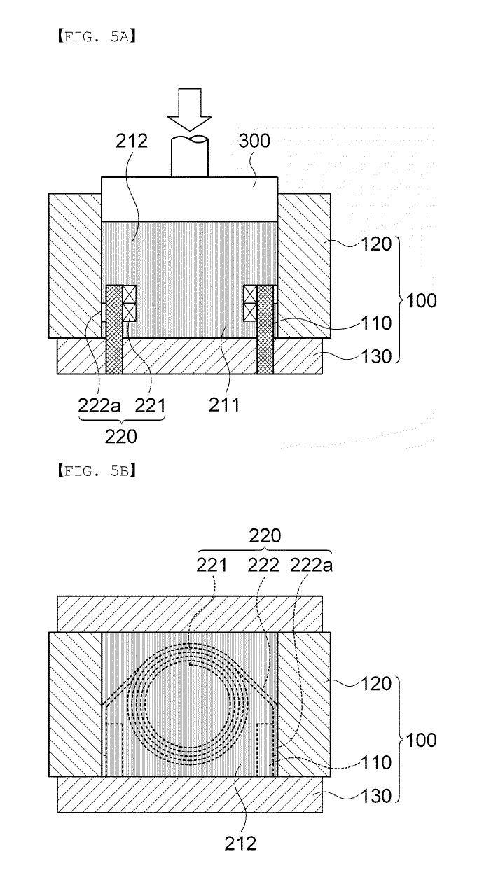

After the left and right sidewalls 120 are slid, the magnetic slurry 212 are filled in the mold 100 and is then pressed primarily, as shown in FIGS. 5A and 5B.

The magnetic slurry 212 is made of the same material as that of the magnetic plate 211. More specifically, the magnetic slurry 212 may be prepared by an organic binder, a plasticizer, and the like, to powders of at least one selected from a group consisting of a Fe based material, a Fe—Si based material, a Fe—Al based material, a Fe—Ni based material, and a Fe—Al—Si based material and wet-mixing them with each other by a mixing method such as a ball mill method, a basket mill method, or the like. If necessary, a volatile solvent for adjusting a viscosity may be mixed.

The magnetic slurry 212 prepared as described above is filled in the mold 100. In this case, it is important to fill a sufficient amount of magnetic slurry 212 in consideration that the fixing pins 110 are discharged to the outside of the mold 100 in the subsequent process. Otherwise, due to insufficiency of the magnetic slurry 212, a defect that an upper portion of the coil 220 is exposed to the outside may occur after the coil 220 is finally completed.

A press plate 300 is positioned in an opening part of an upper portion of the mold 100 and is then pressed downward at a predetermined pressure condition, for example, a compression strength of 5 Kgf for 20 seconds. Therefore, the magnetic slurry 212 to which a predetermined pressure is applied buries the coil 220 therein in the state in which it maintains a predetermined viscosity or more.

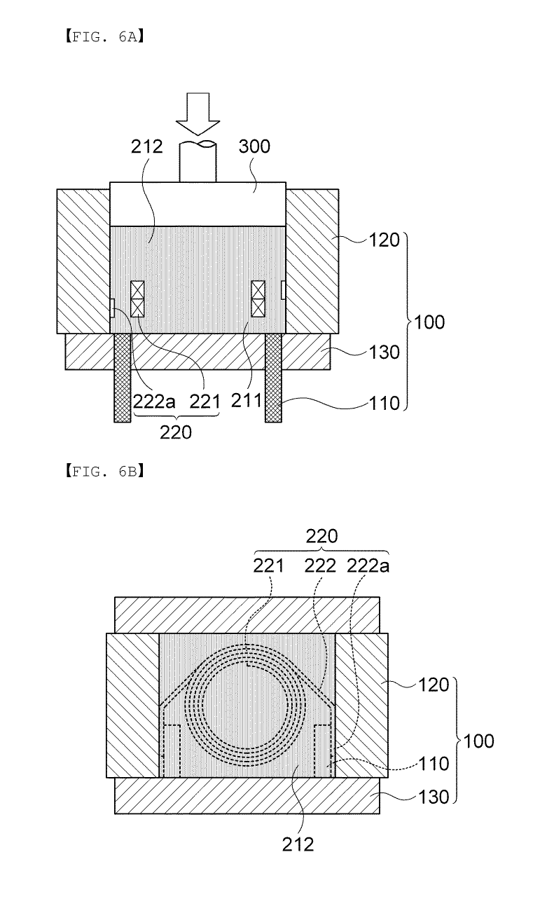

Then, as shown in FIGS. 6A and 6B, the fixing pins 110 is lowered vertically to perform secondary pressing. In this case, the fixing pins 110 are not completely discharged to the outside of the mold 100, but stop as soon as upper distal ends of the fixing pins 110 and the bottom surface of the mold 100 are positioned on the same plane. This may be controlled by movement of a motor connected to the fixing pins 110.

When the secondary pressing performed using the press plate 300 in the state in which the fixing pins 110 are lowered vertically as described above, the magnetic slurry 212 is filled in a space occupied by the fixing pins 110 to completely seal the coil 220.

Here, it is to notice that a compression strength of the primary pressing is set to be lower than that of the secondary pressing. The secondary pressing is performed by pressing the press plate 300 at a compression strength of, for example, 10 Kgf for 20 seconds. As a result, the magnetic slurry 212 is solidified in a semi-hardened state. Therefore, when the compression strength of the primary pressing is set to be higher than that of the secondary pressing, the magnetic slurry 212 is solidified, such that it may not be filled in the space occupied by the fixing pins 110 in the secondary pressing.

When the secondary pressing ends as described above, finally, the left and right sidewalls 120 are opened to discharge a molded product, and the discharged molded product is sintered under a predetermined condition to completely harden the magnetic plate 211 and the magnetic slurry 212 integrally with each other, thereby finally completing the coil according to the exemplary embodiment of the present invention.

According to the exemplary embodiment of the present invention, the left and right sidewalls of the mold are slid to stably fix the coil in the mold, thereby making it possible to prevent the coil from being deformed or deviating from a predetermined position at the time of molding the coil. Therefore, reliability of a product may be significantly improved.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A method of manufacturing a coil, comprising:
preparing a mold having vertically movable fixing pins disposed therein and slidable left and right sidewalls;
seating a magnetic plate on an inner bottom of the mold;
loading the coil on the magnetic plate so that lead parts of the coil are disposed between the fixing pins and the sidewalls of the mold;
sliding the left and right sidewalls of the mold into the mold to closely adhere the lead parts of the coil to the fixing pins;
filling a magnetic slurry in the mold and primarily pressing the magnetic slurry; and
lowering the fixing pins to perform secondary pressing.

2. The method according to claim 1, wherein the fixing pins are configured in pairs and are spaced apart from each other by a predetermined interval.

3. The method according to claim 1, wherein the magnetic plate has a convex shape.

4. The method according to claim 3, wherein in the seating of the magnetic plate in the inner bottom of the mold, a convex part is positioned between the fixing pins.

5. The method according to claim 1, wherein in the lowering of the fixing pins, the fixing pins stop when upper distal ends of the fixing pins and an inner bottom surface of the mold are positioned on the same plane.

6. The method according to claim 1, further comprising sintering a molded product obtained after the performing of the secondary pressing.

7. The method according to claim 1, wherein the coil is an air core coil including a winding part formed by winding a conducting wire in a spiral shape and two lead parts extended from both ends of the winding part and protruding outward.

8. The method according to claim 1, wherein the magnetic plate and the magnetic slurry are made of at least one selected from a group consisting of a Fe based material, a Fe—Si based material, a Fe—Al based material, a Fe—Ni based material, and a Fe—Al—Si based material.

9. The method according to claim 1, wherein the primary pressing and the secondary pressing are performed by positioning a press plate in an opening part of an upper portion of the mold and pressing the press plate downward, and a compression strength of the primary pressing is set to be lower than that of the secondary pressing.
